(19) United States
(12) Patent Application Publication
(10) Pub. No.: US 2020/0163350 A1
(43) Pub. Date: May 28, 2020

(54) FOOD PRODUCT AND METHOD OF MAKING A FOOD PRODUCT

(71) Applicant: PRODUCTOS NATURALES INNOCAMPO S.A. DE C.V., Hidalgo (MX)

(72) Inventors: Simon SACAL MIZRAHI, Bosques de las Lomas (MX); Gabriel SACAL MIZRAHI, Bosques de las Lomas (MX); Alejandro SACAL MIZRAHI, Bosques de las Lomas (MX)

(21) Appl. No.: 16/060,798

(22) PCT Filed: Jan. 13, 2017
(86) PCT No.: PCT/IB17/00014

§ 371 Date: Jun. 8, 2018

Related U.S. Application Data
(60) Provisional application No. 62/279,539, filed on Jan. 15, 2016.

(51) Int. Cl. A23B 7/02; A23L 5/00; A23L 19/00

(52) U.S. Cl. CPC A23B 7/02; A23L 19/03; A23L 5/55

(57) ABSTRACT

It is provided a food product made from fresh food, wherein said food product comprises a first amount of fresh food and a second amount of fresh food and said fresh food may be a fresh fruit or vegetable. A method for preparing said food product is also provided.

### FIELD OF THE INVENTION

This invention relates to a food product and a method for making the food product. The food product comprises natural fresh fruit or vegetable ingredients only and is able to maintain organoleptic properties from the fresh fruit or vegetable, such as flavor and color and nutritional values.

### BACKGROUND OF THE INVENTION

At present, people are aware of the negative effects that highly processed food products and the inclusion of artificial ingredients have on their health. Processed food products and artificial ingredients are associated to diseases or disorders including headaches, hormonal disorders, circulatory problems, cancer, over-weight propensity, obesity, heart problems, and so on.

Consequently, there is a trend towards consuming natural foods such as fruits and vegetables because of their natural nutritional value, their content of vitamins, minerals and antioxidants, allowing keeping good health and preventing diseases. However, consumption of fresh fruits and vegetables is not common since they are usually expensive in regions where, due to climatic reasons, soil quality, or other such reasons, local production of these food types is low. Also, short shelf life of fruits and vegetables makes it difficult for these food types to reach the end consumers.

Several documents relate to methods for preparing food products from fruits or vegetables, however usually these use dehydration techniques such as those mentioned below:

US 2011/0086145 A1: This document divulges a method for producing a dehydrated fruit or vegetable food product, comprising: A) preparing the fruit or vegetable in the following steps; A.i) rinsing, disinfecting, and removing rind and pit or core of the fruit or vegetable, if any; and A.ii) cutting the fruit or vegetable into pieces;

B) dehydrating and puffing the fruit or vegetable pieces to generate an intermediate product with a crunchy texture; C) homogeneously admixing the dehydrated and puffed fruit or vegetable pieces obtained in stage B with a liquid binder suitable for human or animal consumption; D) forming clusters by compression and molding of the admixture of fruit or vegetable pieces and liquid binder obtained in stage C; E) drying the clusters obtained in stage D to substantially remove excess water and recapture the crunchy texture of the fruit pieces.

US 2013/0171325 A1: This document relates to an apparatus and a process for vacuum drying fruit or vegetables, particularly tropical fruit, such as bananas, mangos and pineapples, so as to provide an exceptionally sweet and flavorful fruit chip snack product which is substantially free of any additives such as frying oil, preservatives, added sugar and artificial sweeteners. The process is a vacuum drying process and utilizes a drying apparatus in the form of an autoclave which contains within it a stacked platen heat exchanger wherein trays of the fruit to be dried are placed between heated platens in the heat exchanger. The platens are heated using hot water or a hot water/steam mixture and the drying is done in the autoclave under pressure.

EP 2 263 476 B1: This document is directed to a Composition comprising: (a) whole fruits and/or fruit pieces of at least one fruit type in solid form having a volume of 8 to 6000 mm³, and (b) at least one fruit type in non-solid form having a Bostwick viscosity of 2 to 18 cm in 15 sec (20° C.), characterized in that the component (a) is uniformly distributed in component (b) without addition of thickening agents.

US 2009/0304865 A1: This document divulges a method of making a snack food product comprising, (a) providing a plurality of cut or shaped food pieces; (b) exposing the food pieces to a solution comprising one or more enzymes to coat the surface thereof; (c) thereafter blanching the plurality of food pieces for a time sufficient to inactivate any enzymes on the surface of the food pieces, wherein the food pieces have an initial moisture level after the blanching step; and (d) reducing the initial moisture level to a final moisture level of about 0.5 to about 10% by weight.

WO200928923: This document related to a process for obtaining a stable composition of mango pulp with no enzymatic browning comprising the steps of: a) Dehydrate fresh mango pulp at a temperature of 55-120° C. up to a maximum moisture content of 20-30% w/w, b) Cool the dried pulp at a temperature of 45-55° C. for 5-60 min, c) Dehydrate the pulp obtained in b) to a maximum moisture content of 9% w/w water activity value of 0.25 to 0.6, d) Cool to room temperature the pulp obtained in c), add an additive made by grinding up of: —Maltodextrin as a percentage of 30 to 70% by weight with respect to the total weight of the additives on grinding and —Glucose at a rate of 30 to 70% by weight with respect to the total weight of the milling additive, as a percentage of 1 to 6% by weight with respect to the total weight of the dried pulp, mix and e) grinding the mixture obtained in d) to obtain a particle size of 50-250 micrometers.

US20110091616: This document is directed to a method for obtaining a stable avocado pulp powder dehydrated in a microwave oven, comprising: a) providing a plurality of whole fruits of avocado; b) washing the whole fruits of avocado; c) cutting the whole fruits of avocado in at least two portions; d) retiring the seed of the fruits; e) conducting a first dehydration of the portions of the fruits of avocado in at least a microwave oven that has an air supply, until a maximum humidity content of the pulp between 8 to 12% w/w; f) conducting a second dehydration of the portions of the fruits obtained the first dehydration until a maximum humidity content 2 to 7% p/p; and e) grinding portions of the fruits remaining after the second dehydration to a particle size of 0.5 to 2.5 mm.

FR2650483: This document refer to a process of rehydration of fruits or dehydrated vegetables, in particular applicable to the rehydration of prunes, wherein dehydrated prunes (or other dehydrated fruits or vegetables), in predetermined quantity, and the volume of water necessary to the rehydration of this predetermined quantity, are placed in a container hermetically closed.

WO2012117106: This document divulges a method for obtaining dehydrated chewy and non-sticky dices or pieces of fruits or vegetables, comprising the following steps: a) Providing dices or pieces of fruits or vegetables, b) Pre-drying said dices or pieces of fruits or vegetables, c) Dehydrating the pre-dried dices or pieces of fruits or vegetables obtained in step b) in an instant controlled pressure drop (DIC) reactor, and d) Post-drying of the thus dehydrated dices or pieces of fruits or vegetables, said dehydrated dices or pieces having a springiness comprised between 30 and 40% once rehydrated with 50° C. hot water during one minute.

GB8429587: This document relates to a method for producing a quick-reconstituting foodstuff comprising: removing moisture from frozen foodstuff, from which substantially no moisture has been artificially removed, by subjecting said foodstuff to a forced stream of gaseous medium having a velocity within the range of 350 to 2,000 F.P.M. effective to fluidize said foodstuff and having a dry bulb temperature in the range of about 250 (degree) F. to 350 (degree) F. and a wet bulb temperature in the range of about 120 (degree) F. to 160 (degree) F. and then further dehydrating said foodstuff in an atmosphere having a dry bulb temperature of less than about 220 (degree) F. to produce a finish-dried foodstuff having a storage stable moisture content of less than about 12% by total weight and exhibiting a Rehydration Ratio representing the replacement of at least 90% of previously removed moisture after reconstitution for less than about 15 minutes in simmering water.

Therefore, there is a need for food products made exclusively from fresh natural fruits and vegetables, products which keep organoleptic properties from natural fruits and vegetables, food products which do not include processed supplements and allow overcoming the shortcomings of short shelf life of said fresh. Thus, food products that bring the benefits of fresh, natural foods to the end consumer are required.

### BRIEF DESCRIPTION OF THE INVENTION

The present invention provides a food product comprising at least one fresh natural fruit or vegetable ingredient, wherein the fresh natural ingredient can be selected from at least one fruit such as banana, mango, pineapple, peach, pear, apple, etc.

In some embodiments, the food product may comprise at least one fresh natural vegetable such as, for instance, carrots or potatoes, among others.

The food product may be shaped into any suitable form appropriate for human consumption.

In some embodiments, the food product made from fresh natural fruit may further comprise one or more fresh natural vegetables such as, for instance, carrots, potatoes, among others.

The food product of the invention may be prepared from a single fresh natural ingredient or from two or more fresh natural ingredients.

The food product made from fresh fruit or vegetable of the invention has a longer shelf life than the original fruit or vegetable, while keeping the benefits and organoleptic properties of the fresh fruit or vegetable from which it is made.

Advantageously, the food product of the invention does not comprise additives, flavorants, added sugar, or an additional ingredient not pertaining to the fresh natural fruit or vegetable.

A method for preparing the food product made from at least one natural fresh fruit or vegetable ingredient is also provided. The method of the invention keeps the organoleptic properties from the fresh fruit or vegetable from which it is made such as flavor, nutritional values and color, in the food product.

### DESCRIPTION OF THE FIGURES

These and other features of the invention will be more readily understood from the following detailed description of the various aspects of the invention taken in conjunction with the accompanying figures that depict various embodiments of the invention:

FIG. 1 illustrates a simplified flow diagram of a method for making a fruit product according to an embodiment of the invention.

FIG. 2 illustrates a simplified flow diagram of a method for making a fruit product according to an alternative embodiment of the invention.

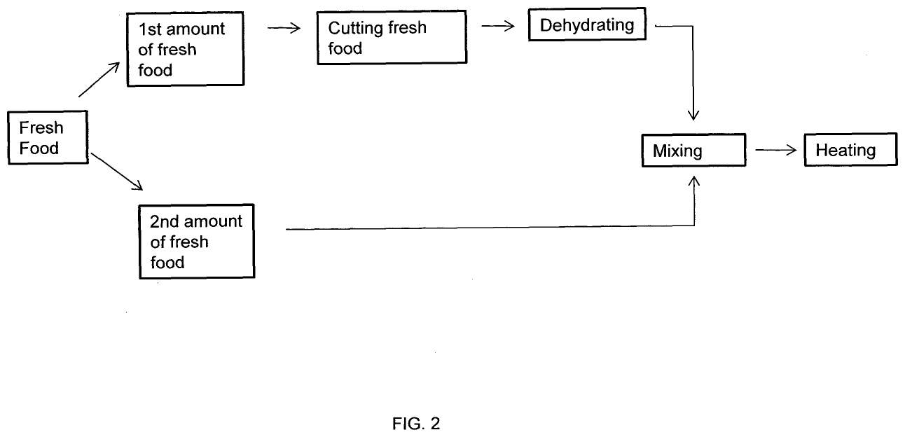

### DETAILED DESCRIPTION OF THE INVENTION

The use of the term “approximately” or “about” provides an additional determined range. The term is defined in the following way. The additional range provided by the term is about +10%. By way of example, but not limitative, if it reads “about 40° C.” or “approximately 40° C.”, the considered range is between 36 to 44° C.

The term “food product” refers to a final food product made from fresh food. Examples of fresh food are fruits or vegetables including banana, mango, pineapple, carrots, potatoes, papaya, mamey (Pouteria sapota), blueberry, strawberry, apple, pear, apricots, cherry, and tangerine, among others.

The term “fresh food” refers to fresh fruit or vegetable in its natural state, comprising, among others, the above-mentioned fruit and/or vegetables.

Particularly, the food product of the invention comprises a mixture of a first amount of fresh food and a second amount of fresh food, keeping the organoleptic properties of the fresh food from which it is made, such as color and flavor, wherein the first amount may be equal to or different than the second amount.

As stated above, the first and second amounts of fresh food are obtained from fresh food, preferably the same fresh food.

The first amount of fresh food is preferred in pieces, which may be that the fresh food is cut, diced or sliced or may be shaped in other forms allowing reduction of the area size with respect to the fruit or vegetable in its original size. In an embodiment, the size of the fresh food pieces of the first amount is homogenous.

The fresh food for the second amount may be mashed, pureed, blended, sieved, pressed, milled, grinded or pulverized, generally rendering a paste

Alternatively, the juice of fresh fruit or vegetable may be used rather than the second amount of fresh food.

The ratio of the second amount of fresh food ranges from about 3% to about 50% by weight, preferably from about 3% to about 30%, more preferably from about 5% to about 20% by weight respect to the food product. The first amount of fresh food is present in a ratio ranging from about 50% to about 97%, preferably from about 70% to about 97%, and more preferably from about 80% to about 95% by weight respect to the food product.

The dehydrated pieces obtained from the process carried out to the first amount may have a maximum moisture content of about 30%, preferably ranging from about 3% to about 20% by weight.

The food product may have a final moisture content lower than about 40%, preferably the moisture content of the food product may range from about 9% to about 35% by weight.

As should result evident for a skilled person, fresh fruits or vegetables for the fresh food may have different moisture degrees, thus resulting in an apparent overlapping of averaged moisture contents for the dehydrated pieces obtained from the first amount with respect to the final product.

In another embodiment, the first amount of fresh food in dehydrated pieces has a lower moisture content than second amount of fresh food.

In an embodiment, the moisture content of the second amount of fresh fruit is similar to or the same than that of the original fresh food. Alternatively, the second amount of fresh fruit may have a moisture content below the moisture content of fresh food in its original state.

In an embodiment, the first amount of fresh food and the second amount of fresh food may be obtained from the same or different fresh food sources.

The method for preparing the food product of the invention comprises a dehydration step and a mixing step. The dehydration step comprises:
a) obtaining pieces of fresh food; and
b) dehydrating the pieces of fresh food at a temperature sufficient to reduce water content to a maximum moisture content of about 30% by weight, preferably from about 5% to about 20% by weight, for a determined time to obtain dehydrated pieces.

The dehydration step temperature is preferred not to exceed about 90° C. In a preferred embodiment, the dehydration temperature ranges from about 55° C. to about 80° C.

Dehydration time for fresh food is preferred not to exceed about 25 hours, and should preferably be from about 5 hours to about 20 hours.

The mixing step comprises:
a) mixing the dehydrated pieces with a second amount of fresh food;
b) heating the resulting mixture at a temperature sufficient to allow moisture content to increase with respect to moisture content of the dehydrated pieces for a determined time, obtaining a food product having a moisture content lower than about 60% by weight.

The heating temperature in the mixing step is preferred not to exceed about 100° C., preferably the temperature ranges from about 35° C. to about 90° C.

The heating time in the mixing step is preferred not to exceed about 50 minutes, and preferably ranges from about 0.5 minutes to about 25 minutes.

The fresh food from which the dehydrated pieces are obtained from may be the same or different type of fresh food from which the second amount is obtained from, however, the same fresh food is preferred for both the first and second amounts.

The method of the invention eliminates the need of using enzyme or similar solutions from the prior art to avoid or reduce browning (oxidation) of the food product, browning which confers an unpleasant color to the resulting food product.

The second amount of fresh food is a paste, preferably obtained from mashing, puree, blending, sieving, pressing, milling, grinding, or pulverizing the second amount of fresh food. The paste from fresh food for the second amount is obtained from using conventional techniques. Advantageously, the second amount of the fresh food does not contain additional sugars, sweeting agents, preservatives, colorants, or further additives not pertaining to the fresh food. The second amount of the fresh food maintains the natural properties of the fresh food such as color, taste, and in some cases its original moisture and nutritional values. In some embodiments, said second amount is substituted with juice obtained from fresh food.

The mixing of the dehydrated pieces obtained from the first amount of fresh food with the second amount of fresh food is preferred to be carried out by mechanical means to ensure homogeneity of the mixture. Additionally, prior to the mixing step, the dehydrated pieces may be additionally cut, diced or sliced. This may be carried out to remove defective parts found in the dehydrated pieces or remaining seed parts.

After the mixing step, the resulting food product may be shaped as desired.

In a second embodiment, the method for preparing the food product comprises:
a) from a first amount of fresh food, obtaining pieces of fresh food;
b) mixing said pieces of fresh food with a second amount of fresh food, wherein the second amount is a paste as defined above;
c) heating said mixture at a temperature which does not exceed about 100° C., preferably from about 35° C. to about 90° C., for a determined time to obtain a food product.

The heating time in the second method embodiment does not exceed about 25 hours, preferably from about 4 to about 20 hours.

The moisture content of the food product obtained from the second method embodiment is lower than about 40%, preferably from about 9% to about 35% by weight.

Alternatively, a juice may be used rather than the second amount of fresh food.

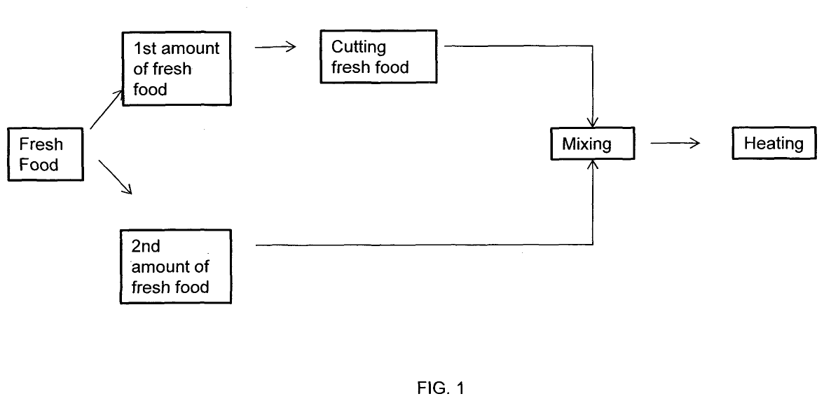

The general steps for the method for preparing a food product according to the first and second embodiments of the invention are illustrated in FIGS. 1 & 2.

The moisture content measurements are performed in a thermobalance. In general terms, a sample obtained from the dehydrated pieces resulting from the dehydrating step is placed in a thermobalance at a temperature of about 105° C. for about 5 minutes to obtain the moisture content. Similarly, a sample of the final product as obtained from the mixing step is placed in a thermobalance at a temperature of about 110° C. for about 10 minutes to obtain the moisture content.

### EXAMPLES

The following examples illustrate some of the preferred embodiments of the invention.

### Example 1

Three food products made of different fresh food were prepared using the methods disclosed previously. The resulting food products under the indicated conditions

| | Fruit 1 | Fruit 2 | Fruit 3 |
|---|---|---|---|
| Dehydration step: | | | |
| Temperature: | 80° C. | 80° C. | N/A |
| Time: | 8 hours | 7 hours | N/A |
| Moisture content: | 8.2% | 11% | N/A |
| Mixing step: | | | |
| Fresh second | 13% | 10% | N/A |
| amount: Dehydrated | | | |
| amount ratio: | | | |
| Fresh second | N/A | N/A | 5% |
| amount: fresh | | | |
| first amount | | | |
| ratio: | | | |
| Temperature: | 65° C. | 65° C. | 80° C. |
| Time: | 2 minutes | 2 minutes | 8 hours |
| Moisture content | 16.3% | 12% | 11.89% |
| of the final food | | | |
| product: | | | |

### Example 2

| | Fruit 1 | Fruit 2 | Fruit 3 |
|---|---|---|---|
| Dehydration step: | | | |
| Temperature: | 80° C. | 80° C. | N/A |
| Time: | 10 hours | 9 hours | N/A |
| Moisture content: | 12.5% | 12.8% | N/A |
| Mixing step: | | | |
| Fresh second | 13% | 10% | N/A |
| amount: Dehydrated | | | |
| amount ratio: | | | |
| Fresh second | N/A | N/A | 8% |
| amount: fresh | | | |
| first amount | | | |
| ratio: | | | |
| Temperature: | 65° C. | 65° C. | 80° C. |
| Time: | 9 minutes | 7 minutes | 10 hours |
| Moisture content | 17.8% | 16.6% | 14% |
| of the final food | | | |
| product: | | | |

### Example 3

| | Fruit 1 | Fruit 2 | Fruit 3 |
|---|---|---|---|
| Dehydration step: | | | |
| Temperature: | 80° C. | 80° C. | N/A |
| Time: | 13 hours | 10 hours | N/A |
| Moisture content: | 15% | 14% | N/A |
| Mixing step: | | | |
| Fresh second | 13% | 10% | N/A |
| amount: Dehydrated | | | |
| amount ratio: | | | |
| Fresh second | N/A | N/A | 12% |
| amount: fresh | | | |
| first amount | | | |
| ratio: | | | |
| Temperature: | 65° C. | 65° C. | 80° C. |
| Time: | 11 minutes | 8 minutes | 12 hours |
| Moisture content | 18.3% | 17% | 16% |
| of the final food | | | |
| product: | | | |

The second amount of fresh food was used in the form of a paste and the first amount of fresh food as cut pieces.

The resulting food product obtained from any of the disclosed embodiments may be combined with additional ingredients such as walnuts, chocolate, yoghurt, honey, chili, cinnamon, cereal, etc.

The food product obtained with this method preserves the organoleptic features of the fruit or vegetable, such as flavor, natural values and color from the original fruit or vegetable.

The food product has a sweet flavor derived from the natural sugars of the fruit or vegetable. No additional sugars or sweeteners are added.

As should be evident for a skilled technician, the food product of the invention comprises only fresh fruit or vegetable or a combination thereof. No additional ingredients, organic or otherwise, such as added sugar, additives, preservatives, colorants, flavorants, etc., are added.

The above described embodiments are merely illustrative for the principles of the present invention. It is understood that modifications and variations of the arrangements and the details described herein will be apparent to others skilled in the art. It is the intent, therefore, to be limited only by the scope of the impending patent claims and not by the specific details presented by way of description and explanation of the embodiments herein.

1. A food product comprising a mixture of a first amount of fresh food and a second amount of fresh food, wherein the first amount is dehydrated and has a lower moisture content than second amount of fresh food, and wherein the food product keeps the organoleptic properties of the fresh food.

2. The food product of claim 1, wherein the second amount of fresh food is a paste.

3. The food product of claim 1, wherein the fresh food is selected from banana, mango, pineapple, carrots, potatoes, papaya, mamey (Pouteria sapota), blueberry, strawberry, apple, pear, apricots, cherry, or tangerine.

4. The food product of claim 1, wherein the food product has a moisture content lower than about 40%.

5. The food product of claim 4, wherein the moisture content of the food product ranges from about 9% to about 35% by weight.

6. The food product of claim 1, wherein the dehydrated first amount of fresh food present a maximum moisture content of about 30%.

7. The food product of claim 6, wherein the dehydrated first amount of fresh food has a moisture content ranging from about 5% to about 20% by weight.

8. The food product of claim 1, wherein the fresh food for the first amount of fresh food and the second amount of fresh food are obtained from the same source.

9. The food product of claim 1, wherein the second amount of fresh food is a fresh fruit in form of a juice.

10. The food product of claim 1, wherein the ratio of the second amount of fresh food ranges from about 3% to about 50% by weight of the food product and the ratio of the first amount of fresh food ranges from about 50% to about 97% by weight of the food product

11. A method for preparing a food product comprising a mixture of a first amount of fresh food and a second amount of fresh food, wherein said method comprises:
a dehydration step comprising:
obtaining pieces of fresh food; and
dehydrating the pieces of fresh food at a temperature sufficient to reduce water content to a maximum moisture content of about 30% by weight, for a determined time to obtain dehydrated pieces;
a mixing step comprising:
mixing the dehydrated pieces with a second amount of fresh food;
heating the resulting mixture at a temperature sufficient to allow moisture content to increase with respect to moisture content of the dehydrated pieces for a determined time, obtaining a food product having a moisture content lower than about 40% by weight.

12. The method of claim 11, wherein the dehydration step temperature does not exceed about 90° C.

13. The method of claim 11, wherein the dehydration time does not to exceed about 25 hours.

14. The method of claim 11, wherein the heating temperature in the mixing step is preferred not to exceed about 100° C.

15. The method of claim 11, wherein the heating time in the mixing step is preferred not to exceed about 50 minutes.

16. A method for preparing a food product comprising a mixture of a first amount of fresh food and a second amount of fresh food, wherein the method comprises the following steps:
a) cutting a fresh fruit or vegetable into pieces to obtain a first amount of fresh food;
b) mixing said first amount with a second amount of fresh food; and
c) heating said mixture at a temperature which does not exceed about 100° C. for a determined time to obtain the food product.

17. The method of claim 16, wherein the heating time does not exceed about 25 hours.

18. The method of claim 16, wherein the moisture content of the food product is lower than about 40%.

19. The method of claim 16, wherein the second amount of fresh food is a fresh fruit in form of a juice.
